(19) United States
(12) Patent Application Publication
(10) Pub. No.: US 2005/0121414 A1
(43) Pub. Date: Jun. 9, 2005

(54) Process of producing metal-decorating material; metal-decorating material and the use thereof

(75) Inventor: Thanpuying Supornpen Luangthep, Bangkok (TH)

Correspondence Address: Ladas & Parry, 26 West 61 Street, New York, NY, 10023, US

(73) Assignee: THE FOUNDATION FOR THE PROMOTION OF SUPPLEMENTARY OCCUPATIONS & RELATED TECHNIQUES OF HER MAJESTY QU

(21) Appl. No.: 10/862,894

(22) Filed: Jun. 7, 2004

(30) Foreign Application Priority Data
Dec. 9, 2003 (TH) 087252

(51) Int. Cl. B32B 15/00

(52) U.S. Cl. 216/32; 428/687

(57) ABSTRACT

Process of producing metal-decorating material, which causes no pollution to the environment and can be used both in industrial manner and handicrafts, for decorating equipment or process of decorating of various equipment surface, e.g. furniture, weapons, purse, night pouch, etc is disclosed.

### SUMMARY OF THE INVENTION

The invention purports to a process of producing metal-decorating material for decorating equipment; or a process of decorating of various equipment surface, e.g. furniture, weapons, purse, night pouch, etc.

1. Field of the Invention

The present invention relates to a process of production of metal-decorating material of various designs, without the use of chemical substance, which is the cause of pollution.

2. Background of the Invention

In the production of any equipment, apart from the consideration of their utility, the aesthetics must be taken into account as well. There are different methods of decoration and beautification, e.g. carving, enamelling or decorating with valuable materials, etc.

In case of metal equipment, different methods can be used to make decoration. However, in case that the decoration must involve the etching on the metal surface, the chemical substance is often used. Yet, there is a disadvantage that mostly the chemical substance will cause pollution.

### DETAILED DESCRIPTION OF THE INVENTION

The invention purports to a process of producing metal-decorating material, which causes no pollution to the environment and can be used both in industrial manner and handicrafts.

The term “metal-decorating material” used hereinafter both in this description and in the claims will include decorating material which is made of metal and can be used to decorate equipment made of metal or any other materials; or this process can be used directly to decorate metal equipment.

The process of producing metal-decorating material of the invention consists of the step of making a pollenlike holder on the main metal surface which forms the base of the decorating material or the equipment's body being made of metal; and the step of setting the design-creating material on the surface of the main material by using said pollenlike holder in setting the design-creating material on the surface of such main metal.

The design-creating material may be any kind of materials, which will embellish such main metal. As an embodiment of the invention, it is preferable to use precious metal, according to the table, as design-creating material e.g. gold, silver, platinum, etc. In this case, it is appropriate to roll or draw such precious metal to become small a thin thread about the size of a hair thread with the diameter of around 17 to 181 micrometers. In case that the decorating-material plate is produced before making decoration of the equipment's surface, the main metal plate should not be more than 1 millimeters thick, even though the thickness and the width of the precious metal as well as the thickness of the main metal plate are not a critical point.

The process of producing the pollenlike holder could be done by etching such main metal's surface, without using any chemical substance, but using any instrument that could cause marks on the surface, e.g. a chisel, etc. Here, machines or human labour directly, may be used depending on the fineness of the work-piece desired.

As an embodiment of the invention, etching is defined as making the pollenlike marks on the surface of the main metal in order to be able to hold the design-creating material. This can be executed in the way that such marks cut across in different directions, either for 4 to 8 times or 4 to 8 directions

Such etching marks may be operated in different directions as follows:

1. From the north to the south, i.e. from the top of the main metal towards the bottom in the perpendicular line, or vice versa.

2. From the west to the east, i.e. from the left of the main metal towards the right in parallel line with the horizontal level, or vice versa.

3. From the north-east to the south-west, making an angle of 40-50 degrees to the line according to the 1^{st} order above, or vice versa.

4. From the northwest to the southeast, making an angle of 40-50 degrees to the line according to the ^{st} order above, or vice versa.

As an embodiment of the invention, the etching may be operated each time in one direction or more, depending on the instruments used. Likewise, the next etching may be operated in the same direction, reversed direction, opposite direction or crosswise against the previous one. The operation may be at least for 4 times (directions) or more, up to 8 times (directions). As an embodiment of the invention, the etching may be operated following the direction in order 1, 3, 4, and 2 as mentioned above respectively, or can be done reversely; or the etching operation may be opted to increase to 5-8 times or directions, following the order 3, 4, 1 and 2 or the reverse order.

In addition, by a characteristic of this invention, it is optional in each time or each direction of the etching operation, to apply different degrees of heavy or light force as desired, e.g. by the above-mentioned characteristic, the force put in the fifth etching may be lighter than that applied in the second one even though both are operated in the same direction. It's also optional to make a set operation, i.e. the force applied in the first round etching may be stronger than that used in the second round. Moreover, the etching may be operated in the same direction at the angle of equal degrees, or some different degrees. However, the different angles of about 1-5 degrees are appropriate; etching operation may be opted by using etching instrument to make an angle of 70-120 degrees against the main metal's surface; the more preferable is 80-100 degrees.

By a characteristic of the invention, the design-creating material will be fixed on the surface of the main metal which is already etched into the pollenlike holder, in any designs as desired, making the pollenlike holder be able to hold the design-creating material by using any process, e.g. use a setting instrument. Additionally, the design-creating material may be fixed at the end of either times of the etching operation, as from the 4^{th} time to the 8^{th} time as desired.

As an embodiment of the invention, the opaque-area in the surface between decorating design may be punctured to become partly or entirely transparent space, by using any means, e.g. fretting or cutting off by any means.

As an embodiment of the invention, the puncture may be done in the manner that the edge of such design stays in the right angle between both surface, in slanted angle, or in the way that the design follows one after another in orderly fashion.

As an embodiment of the invention, the process of this invention may be used to produce design decoration on both surface, either being the same design or not; or it can be done only on a single surface.

As an embodiment of the invention, metal-decorating material of this invention will consist of a piece of main metal that is etched to be pollenlike holder on the surface and the design-creating material held by such pollenlike holder. Accordingly, this pollenlike holder will function as a setter of the design-creating material, making it unmovable, without the use of any chemical substance. Thus, this will render economy and reduce pollution.

As an embodiment of the invention, metal-decorating material produced by using this process may be used to decorate equipment and instruments both made of metal or any other materials, e.g. night pouch, photo frame, box, small casket, decorated gable end of royal or religious traditional Thai building, top roof of the junk, etc. Moreover, the process of this invention may be used to make the designs on the surface of any equipment and instruments as desired.

1. The process of producing metal-decorating material, comprises the steps of
a) making a pollenlike holder on the surface of the main metal and
b) setting the design creating material on the surface of the main metal.

2. The process of claim 1 wherein the pollenlike holder is produced by etching the surfaced of the main metal.

3. The process of claim 2 wherein the etching is operated in the cross directions for 4-8 times or for 4-8 directions.

4. The process of claim 2 wherein the etching directions may be optionally selected from the groups of
4.1 from the north to the south or vice versa.
4.2 from the west to the east or vice versa.
4.3 from the northeast to the southwest or vice versa.
4.4 from the northwest to the southeast or vice versa.

5. The process of claim 4 wherein said directions may be slanted, making any angles of different degrees.

6. The process of claim 4 wherein may optionally select the directions as mentioned in item 4.3 and 4.4 to make an angle of 40-50 degrees with the direction in 4.1.

7. The process of claim 4 wherein may be optionally etched as above directions in the same direction, reverse direction or cross direction to the previous one.

8. The process in claim 3 characterized that the etching operation may be opted for 2 or more times in the same direction, but different angle from 1-5°.

9. The process of claim 7 characterized that may be optionally selected to etching in the direction as mentioned in claim 4 in order 4.1, 4.3, 4.4 and 4.2 or vice versa.

10. The process of claim 9 which may optionally to make any additional etching in the direction in order 4.3, 4.4, 4.1 and 4.2 of claim 4 or in the different order.

11. The process in claim 1 wherein may be selected to put the different force in each time of the etching.

12. The process in claim 1 wherein the angle between the etching equipment and the main metal surface may be optionally selected from 70-120°.

13. The process of claim 12 wherein the angle is 80-100°.

14. The process in 1 which may be selected to set the decorative design material into the pollenlike holder on the main metal surface at the end of the etching in whichever of the fourth time to the eighth time.

15. The process in claim 1 wherein may be selected the said decorative design material from the group of precious metals from the table of elements.

16. The process of claim 15 wherein may be select the precious metal from gold, silver or platinum.

17. The process of claim 16 wherein may be optionally to roll or draw said precious metal to a small thread at the diameter around 17 to 181 micrometers

18. The process in claim 1 wherein may select the opaque areas during the design on the surface of the main metal, in partly or all over the areas, to be transparent space, or to be all opaque areas.

19. The process of claim 18 wherein the transparent space may be produced by fretting or cutting off with any means.

20. The process of claim 18 wherein the transparent space may be produced by puncture or cut at the edge of the decorating design at the right angle or angle of inclination or in the way that the design follows one after another in orderly fashion.

21. The process in claim 1 wherein the same or different decorative design may be produced on both of main surface metal.

22. Metal decorative materials which is produced by the process in claim 1.

23. The use of decorative material produced by the process in any of claim 1 for decorate any equipments.

24. The use of process in claim 1 to produces surface decorated equipment.
